(19) United States
(12) Patent Application Publication
(10) Pub. No.: US 2004/0118666 A1
(43) Pub. Date: Jun. 24, 2004

(54) Fail-safe automotive switch

(76) Inventors: Chris E. McCaig, Oakville (CA); Glen N. McNeill, Burlington (CA)

Correspondence Address: DOWELL & DOWELL PC, SUITE 309, 1215 JEFFERSON DAVIS HIGHWAY, ARLINGTON, VA, 22202

(21) Appl. No.: 10/635,912

(22) Filed: Aug. 7, 2003

(30) Foreign Application Priority Data
Aug. 9, 2002 (CA) 2 397 459

(51) Int. Cl. H01H 7/08

(52) U.S. Cl. 200/38 F

(57) ABSTRACT

The switch of the present invention is designed to detect the position of a latch (e.g., a fork bolt or ratchet) in a vehicle. Specifically, a switch is described and claimed which emits a signal indicative of the position of a latch mechanism. In a further aspect of the invention, the switch is in direct engagement with the associated latch (or portion thereof). In a further feature of the present invention, a switch is described and claimed wherein a switch is adapted to emit a signal that provides diagnostic information of the switch and/or the latch to which the switch is associated. In a further aspect of the invention there is provided a switch that in most circumstances will, in the event of a failure of a switch but not of the latching mechanism, emit a signal indicative of this switch failure thus preventing potentially significant repercussions.

### FIELD OF THE INVENTION

The present invention relates generally to switches and, more particularly, a fail-safe automotive switch.

### BACKGROUND OF THE INVENTION

The automotive industry is under constant pressure to make vehicles safer and more reliable. Additionally, there is also market pressure to provide more features on each car. Still further, there are regulatory pressures on automobile manufacturers to provide warnings and other instruments indicating to a driver that the failure of a component has occurred. Still further, consumers are demanding that the vehicles provide more and more features at a lesser and lesser cost.

As can be expected in this competitive environment, auto manufacturers are demanding that their parts suppliers provide additional functionality, increased reliability, improved quality and technical advances in parts being supplied while at the same time providing these parts at lower costs. This has placed a significant amount of pressure and burden on suppliers.

Due to the operating conditions that an automobile or other vehicle is subjected to, many of the parts and subsystems are required to be very robust in order to operate in these conditions. For example, the engine compartment of an automobile is subjected to extremes in temperature (from −60° C. to upwards of a 150° C.), significant amounts of humidity and moisture either through precipitation or water splashing, salt and other corrosive substances and significant mechanical forces as the vehicle moves at high speed while impacting significant road hazards such as pot holes, frost heaves, speed bumps and the like. Other areas of the vehicle, which may similarly be exposed to the elements are often subjected to the same or similarly difficult environmental conditions. Despite these conditions, operators of these vehicles demand that the components operating within are efficient, long-lived and reliable. Moreover, customers and regulators are demanding that, in the event that one or more of these components fail, the operator should either be warned of the failure and/or be enabled to safely shut down the vehicle. As a result of these demands, some systems are designed to have built in redundancies or fail-safe mechanisms.

For example, the hood of a vehicle normally has two separate devices operating independently to ensure that the hood remains in a closed or latched position during operation. Should the first or main latch fail, a secondary or safety latch is designed to keep the hood in a closed or near-closed position. The secondary latch is designed to prevent the hood of the vehicle from being forced, by a result of significant aerodynamic drag, into the windshield thus preventing significant injury to the vehicle occupants and allowing the operator of the vehicle to have an unobstructed view of the road despite the failure of the first latching mechanism. This particular system has worked exceedingly well in preventing the unsafe operation or an unsafe condition during operation from occurring. In fact, this system has operated so effectively that many drivers or occupants are simply unaware of when the hood is open or being maintained in a near-closed position by the secondary or safety latch. Accordingly, there has developed a need to warn the operator of a vehicle of this unsafe near-closed condition. To satisfy this need, warning instrumentation has been developed to warn a user (usually by way of a warning light or lamp—sometimes derisively referred to the industry as an “idiot light”) of this condition. However, the automotive switches known to the inventors that have been employed to identify the condition of an open or near-closed hood or the failure of the primary hood latch mechanism, have been unsatisfactory for a variety of reasons.

Amongst these reasons are the known high defect rate in the manufacture of these automotive switches, their propensity to fail due to the harsh conditions experienced in the underhood environment, the switch's inability to provide any suitable diagnostic indicators to assist in diagnosing whether a warning light has been illuminated as an indicator of a hood open or latch failure condition or an indicator that the switch itself has failed. Accordingly, it would be desirable to provide an automotive switch that addresses some or all of these shortcomings.

Many operators or owners of vehicles have commenced demanding greater degrees of convenience and usability in their vehicles. One such demand is the ability to provide features and functions related to comfort, especially for vehicles operated in harsh environments (e.g., in extremely hot or humid environmental conditions or extremely cold environmental conditions). For example, owners or operators of vehicles in extreme temperature conditions have begun demanding that their vehicles provide the ability to be remotely started so that the environmental controls (e.g., heating, ventilation and air conditioning systems) can be operated thus heating or cooling the vehicle, as appropriate, prior to the owner or operator entering the vehicle. This features provides enhanced usability and operator comfort. However, while providing remote starting capability is known in the art, such capability should be prevented in the event that the hood is in an open position or the primary hood latch has either failed or is not engaged. Accordingly, an automotive switch which is suitable for such a purpose while addressing some or all of the shortcoming of the switches known to these inventors, is desirable.

It would be further desirable that such an automotive switch for other latching mechanisms in vehicles (e.g., rear hatches, deck or trunk latches, door latches and other compartment latches) be provided.

### SUMMARY OF THE INVENTION

The switch of the present invention is designed to detect the position of a latch (e.g., a fork bolt or ratchet) in vehicle. Specifically, a switch is described and claimed which emits a signal indicative of the position of a latch mechanism. In a further aspect of the invention, the switch is in direct engagement with the associated latch (or portion thereof). In a further feature of the present invention, a switch is described and claimed wherein a switch is adapted to emit a signal that provides diagnostic information of the switch and/or the latch to which the switch is associated. In a further aspect of the invention there is provided a switch that in most circumstances will, in the event of a failure of a switch but not of the latching mechanism, emit a signal indicative of this switch failure thus preventing potentially significant repercussions.

In one aspect of the present invention there is provided a latching mechanism switch comprising: an enclosure; a switching device fixedly mounted within said enclosure; and a cam rotatably mounted to said enclosure, said cam for direct engagement with an associated latching mechanism and said cam having a magnet fixedly mounted thereto, wherein rotation of said cam and said magnet from a first position to a second position causes said switching device to change from an open state to a closed state and wherein rotation of said cam and said magnet from said second position to said first position causes said first switching to change from said closed state to said open state.

In a further aspect of the present invention there is provided a method of operating a latching mechanism switch, said method comprising: directly engaging a portion of said latching mechanism switch with a portion of an associated latching mechanism; and moving said latching mechanism from a first, unlatched position to a second, latched position causes a first reed switch of said latching mechanism switch to change from an open state to a closed state, and wherein moving said latching mechanism from said second position to said first position causes said first reed switch to change from said closed state to said open state.

In a still further aspect of the present invention there is provided a vehicle comprising a latching mechanism and a latching mechanism switch, said latching mechanism switch associated with said latching mechanism, said latching mechanism switch comprising: an enclosure; a first reed switch fixedly mounted within said enclosure; and a cam rotatably mounted within said enclosure, said cam for direct engagement with said associated latching mechanism and said cam having a magnet fixedly mounted thereto, wherein rotation of said cam and said magnet from a first position to a second position causes said first reed switch to change from an open state to a closed state and wherein rotation of said cam and said magnet from said second position to said first position causes said first reed switch to change from said closed state to said open state.

Other aspects and features of the present invention will become apparent to those ordinarily skilled in the art upon the review of the following description of specific embodiments of the invention in conjunction with the accompanying figures.

### BRIEF DESCRIPTION OF THE DRAWINGS

In the figures which illustrate exemplary embodiments of the present invention, the following drawings are provided:

FIG. 1 schematically illustrates aspects of the invention in relation to a fork bolt;

FIG. 2 illustrates, in a different orientation, the switch of FIG. 1;

FIG. 3 illustrates a portion of the switch shown in FIGS. 1 and 2 from a different view;

FIG. 4 illustrates the switch of FIG. 3 in a different view;

FIG. 5 illustrates a semi-transparent view a portion of the switch of FIGS. 1 to 4;

FIG. 6 illustrates in greater detail aspects of FIG. 5;

FIG. 7 illustrates additional portions of the switch of FIG. 5;

FIG. 8 illustrates in greater detail aspects of the invention shown in FIG. 5;

FIG. 9 illustrates in greater detail portions of the embodiment illustrated in FIG. 5;

FIG. 10 illustrates still other portions of the embodiment illustrated in FIG. 5;

FIG. 11 illustrates a second embodiment of the invention;

FIG. 12 illustrates in greater detail portions of the embodiment of FIG. 11;

FIG. 13 illustrates in greater detail portions of the embodiment illustrated in FIG. 12;

FIG. 14 illustrates interior portions of the embodiment illustrated in FIGS. 11 through 13;

FIG. 15 illustrates in greater detail a first wiring embodiment of the embodiment illustrated in FIGS. 11 through 14;

FIG. 16 illustrates a second embodiment of the wiring of the embodiment to the invention illustrated in FIGS. 11 through 14;

FIG. 17 illustrates in greater detail portions of the invention illustrated in FIG. 14; and

FIG. 18 illustrates aspects of the invention in greater detail illustrated in FIG. 16.

### DETAILED DESCRIPTION OF THE PREFERRED EMBODIMENTS

In overview, the embodiments described herein provide a description of a switch for mounting in the underhood environment to provide a fail-safe automotive switch that operates in conjunction with a hood latch mechanism. As persons of ordinary skill in the art will appreciate, the fail-safe switch described herein will, in most circumstances, provide for a signal to be emitted indicative of a failure of the switch itself or of the latch mechanism with which it is associated. Further, and as persons of ordinary skill in the art will appreciate, the embodiments of the switch described herein could equally be used in other environments such as the latching mechanisms that are employed for other enclosures such as the trunk or deck, tailgates, hatches, compartments and doors.

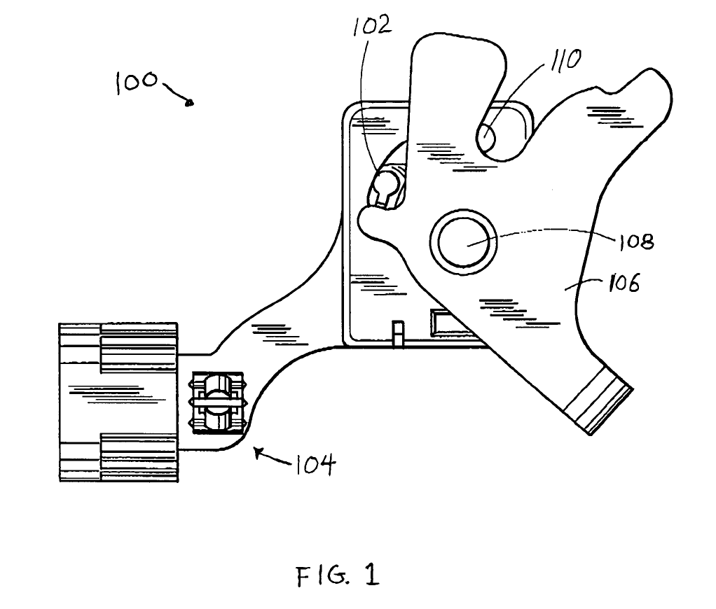

Referring to FIG. 1, an embodiment of the inventive switch described herein is generally identified as switch 100. Switch 100 works in conjunction with fork bolt 106, which forms part of a hood latching mechanism. That is, switch 100 is associated with a hood latching mechanism. In the exemplary embodiment, this association between switch 100 and the latching mechanism is achieved through mounting switch 100 to fork bolt 106. In alternative embodiments, a switch embodying aspects of the present invention may be mounted in close proximity to the associated latching mechanism. For example, the switch may be mounted to some part of the vehicle in a position that results in the operation of the switch when the associated latching mechanism is operated.

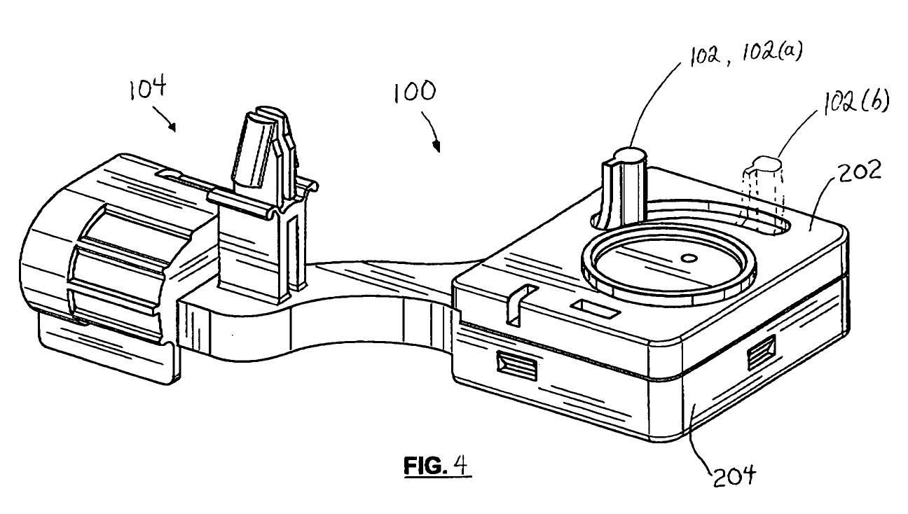

Again referencing FIG. 1, included in switch 100 is switch actuator 102 that is directly engaged with fork bolt 106. That is, the switch actuator 102 is directly coupled and physically interfaces with fork bolt 106. Switch actuator 102, as described in greater detail below, is positively biased against one or more portions of fork bolt 106. As such, by movement of fork bolt 106 (such as the rotation of fork bolt 106 about fork bolt post 108 from an unlatched to a latched position), switch actuator 102 will similarly be translated (or in the exemplary case rotated) from a first position 102a (illustrated in FIG. 4) to a second position 102b (shown in dotted line in FIG. 4). Switch actuator 102 may be directly coupled to the fork bolt 106 simply through a biasing mechanism or, in addition, may be adhered to fork bolt 106 through the use of adhesives, welding or any other suitable fixture device or mechanism. In switches known to the inventors, fork bolt 106 is indirectly coupled to switch actuator 102 by way of a coil spring.

Also shown in FIG. 1 is a connector or wiring harness 104 through which electrical or other connection signals (e.g., optics) are transmitted between switch 100 and the control system of the associated vehicles.

In the present invention, switch actuator 102 is translated through operation of fork bolt 106 through a path that is defined by actuator groove 110. As a result of the inclusion of groove 110, the interior of switch 100 is exposed to the elements (e.g., water, salt, etc.).

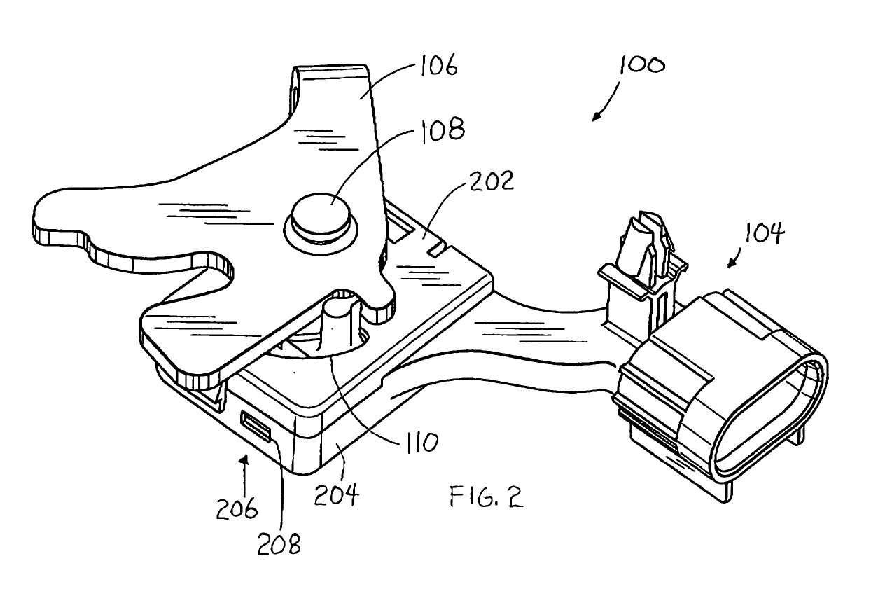

In the embodiment of the present invention illustrated in FIGS. 1 and 2, switch actuator 102 is directly coupled to, and in direct connection with, fork bolt 106. Consequently, although the interior of the switch 100 is exposed to the elements as a result of the actuator groove 110, this exposure, in most circumstances and unlike switches known to the inventors, will not result in failure of the switch 100. For example, switches known to the inventors, as a result of being exposed to the elements and being indirectly coupled to fork bolt 106 by way of a coil or other type of spring, will often be filled with precipitation such as snow or rain. This precipitation will often freeze forming significant amounts of ice in the interior of the known switches. As a result of this ice build-up in the switches known to the inventors, if the fork bolt of the hood latch moves from the locked or closed position to the open position (which indicates that either the hood is open or that the hood is partially ajar and maintained in that position by the secondary or emergency latch), the switch actuator of these switches will not move from the closed position to the failure warning position as a result of this build-up. That is, the ice build-up within the switches known to the inventors, as a consequence of ice build-up between the coils of the extended spring, will result in the spring being unable to recoil to its non-extended position. Consequently, in these switches known to the inventors, an operator of a vehicle will not be warned of this potentially dangerous situation. Similarly, if the hood is slightly ajar or even open, the engine could be started remotely which could lead to a potentially dangerous situation if there is someone working on or in the engine compartment.

In contrast to those switches known to the inventors and despite the existence of the actuator groove 110 exposing the interior of switch 100 to the elements (which may also result in ice build-up), the direct coupling of fork bolt 106 with actuator 102 will result in any ice being broken or cleared through the application of significant forces to fork bolt 106 (in order for it to move from the latched to unlatched or ajar position) being transferred to switch actuator 102. That is, as fork bolt 106 is rotated about fork bolt post 108, it will apply force directly against switch actuator 102. This force, in most circumstances, is sufficient to clear any ice that has built up within the interior of switch 100.

Referencing FIG. 2, switch 100 includes a base substrate 204 and a cover 202 which, through operation of snap assemblies 206, are coupled to form an enclosure which houses most of the components of automotive switch 100. Cover 202 includes, in the exemplary embodiment, fork bolt post 108 about which fork bolt 106 rotates. Also, cover 202 includes a void that forms groove 110 which guides switch actuator 102 as it rotates or translates. That is, switch actuator 102 is positioned such that, as it translates from the position indicating that the fork bolt 106 is in a closed position 102a (also referred to herein as the “fail-safe position”) to position 102b (shown in dotted outline in FIG. 4 and referred to herein as the latched or closed position) it is guided by groove 110.

In the exemplary embodiment cover 202 includes flexible biasing ribs which extend from a position proximate to a bottom edge of the cover each terminating in a fish-hook style wing, thus forming one-half of snap assemblies 206. Base substrate 204, which interacts with cover 202, includes suitably shaped fish-hook wing receiving apertures 208 which receive the fish-hook style wings. That is, by positioning and pressing cover 202 against base substrate 204, cover 202 and base substrate 204 can be removably fixed to one another. Initially, the flexible biasing ribs of the snap assemblies will be pushed towards the interior of switch 100 and then, as the fish-hook style wings are advanced towards the receiving apertures 208, the biasing ribs will force the wings outwards thus forming a mechanical fixture such that base substrate 204 and cover 202 form a fixed enclosure.

The use of snap assemblies 206 to form the enclosure of switch 100 requires generally very little force and transmits very little force or vibration to the interior components of switch 100. In distinct contrast, the switches known to the inventors use ultrasonic welding to fix the cover to the base substrate. However, since ultrasonic welding results in subjecting the base and cover to high frequency vibrations, the interior mechanisms (most notably the electrical components) are similarly subjected to these high frequency vibrations. These high frequency vibrations often result in damage to the electrical components or defects in the connections between these electrical components. Accordingly, the switches known to the inventors often have a high defect rate when manufactured. Consequently, this high defect rate increases the overall unit cost of those switches which, at the time of manufacturing, do not have any defects. Also, while the high frequency vibrations do not always result in damage to the interior components to the point of failure, these interior components are often sufficiently damaged such that the overall life expectancy of the switch is significantly degraded. Accordingly, the switches often fail when in operation resulting in increased maintenance costs to either the consumer or the manufacturer of the vehicle. Additionally, due to these defects, the consumer may be given the impression that the overall quality of the vehicle is sub-standard. These effects—the increased unit cost of manufacture, the increased costs associated with repair or warranty work and the decrease in perceived quality by the owner or operator of the vehicle—are simply unacceptable to vehicle manufacturers. The automotive switch described herein has notably reduced rates of defect during manufacture, an improved life expectancy and a greater level of quality may be perceived.

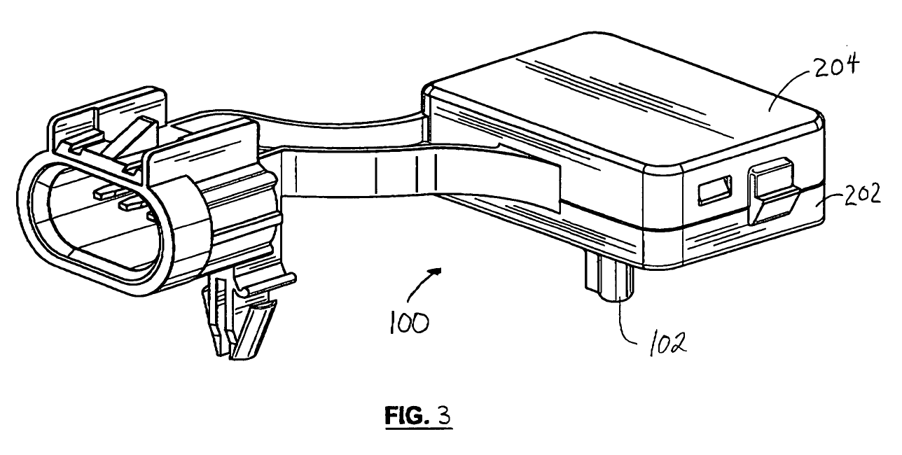

Referencing FIGS. 1-4, switch 100 in the exemplary embodiment is shown with a connector style wiring housing 104 that includes three terminals. Alternative embodiments may include a lesser or greater number of terminals or alternative styles of wiring housing 104.

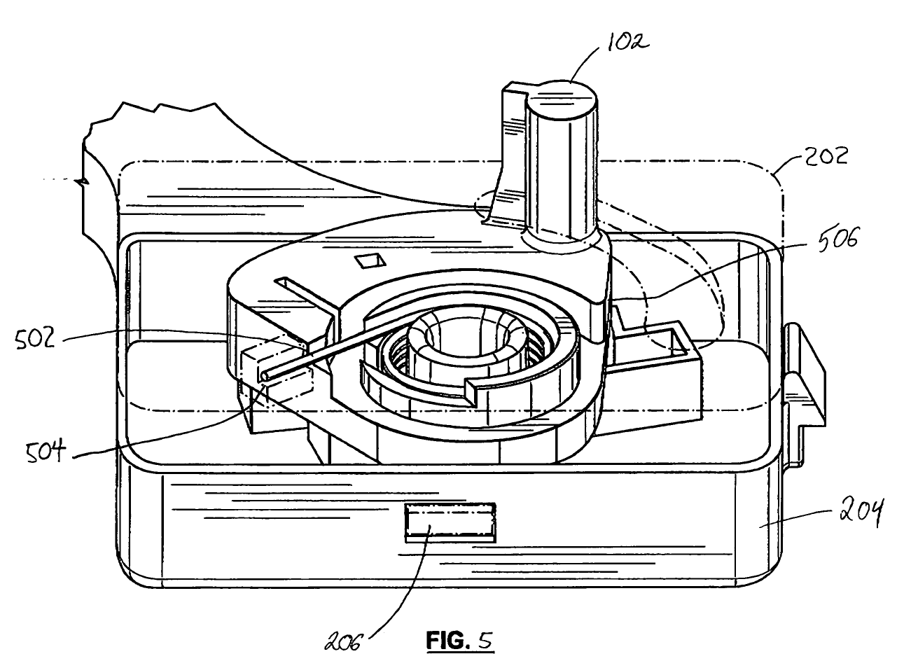

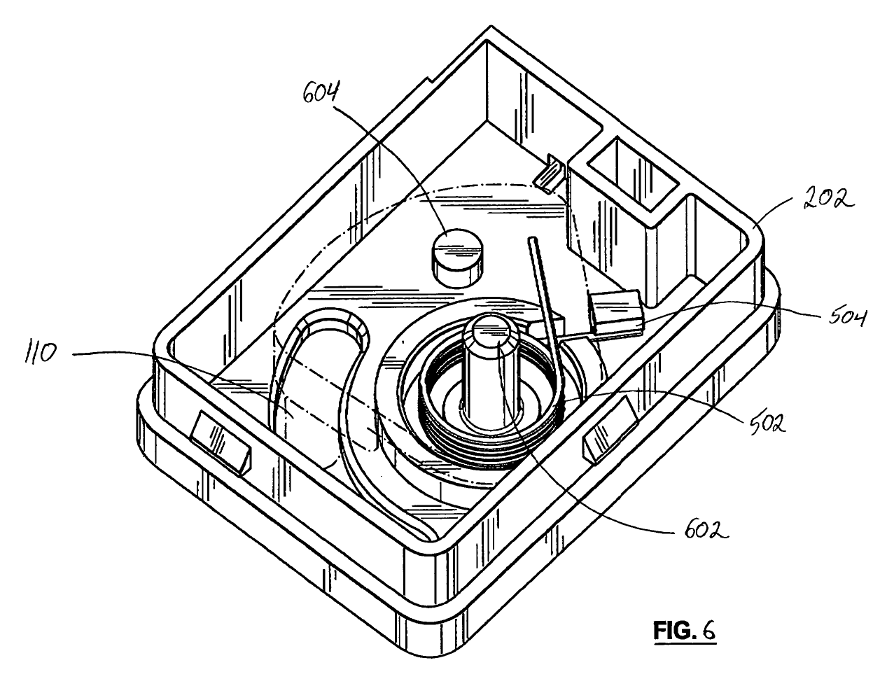

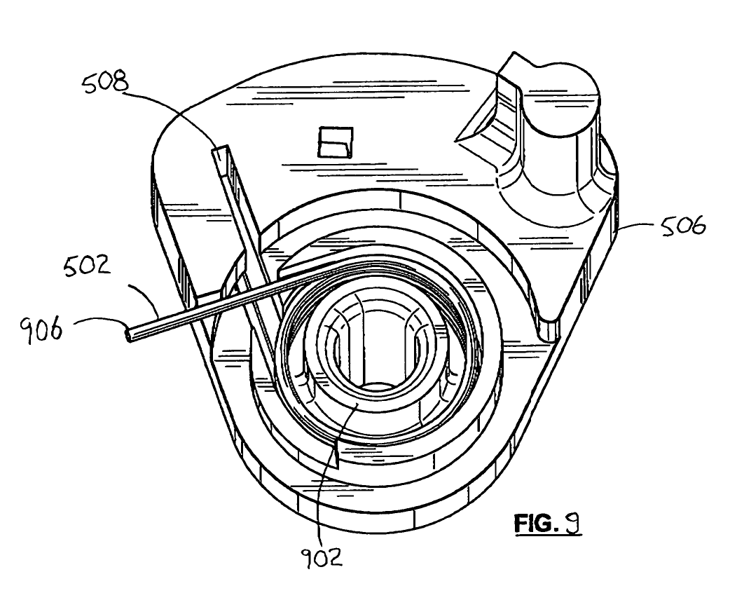

Referring to FIGS. 5 and 6, the interior mechanism of switch 100 and its operation and interaction is shown in greater detail. In FIG. 5, switch actuator 102 is fixedly mounted to cam 506 that rotates about camshaft or post 602 (FIG. 6). In the exemplary embodiment, switch actuator 102 is fixedly mounted to cam 506 as a result of cam 506 be moulded or formed to include switch actuator 102. Additionally, a pre-tensioned helical spring is being coiled about spring tension recess or ridges 904 (see FIG. 9) which forms part of cam 506.

One end of helical spring 502 is fixed within a slot or channel (locking recess 508) forming part of cam 506 while the other end of helical spring 502 is positioned fixed relative to cover 202. The fixation of portions of spring 502 relative to cam 506 and cover 202 is achieved through the pre-tensioning of spring 502 and the placing of ends of spring 502 into recess 504. That is, recesses 508 and 504. As a result of the pre-tensioning of spring 502, the ends of spring 502 are biased against the interior of recesses 508 and 504 thus holding one end of the spring in a fixed position relative to cover 202 and the other end in a position fixed relative to cam 506.

As will be appreciated by those of ordinary skill in the art, other devices which bias cam 506 towards the fail-safe position could be used instead of helical spring 502. For example, leaf springs, compression springs, torsion springs and other biasing mechanisms could be employed in alternative embodiments.

Magnet 604 is fixed into a position relative to cam 506. In the exemplary embodiment, magnet 604 is a disc magnet snap-fitted into this fixed position relative to cam 506. Alternative shapes of magnet 604 and alternative fixation mechanisms could be equally employed to place magnet 604 in a fixed position relative to cam 506.

In FIG. 6, cam 506 and magnet 604 are shown in the fail-safe position 102a. In this position, switch actuator 102 is in the upper portion of groove 110 and helical spring 502 will be in a relatively low energy state.

When fork bolt 106 is in the latched or closed position 102b (shown in dotted outline in FIG. 4), helical spring 502 will be in a relatively high energy state (i.e., in a relatively unsprung position). That is, helical spring 502 will have been further tensioned as a result of cam 506 being rotated as fork bolt 106 moves to its closed or latched position. As fork bolt 106 is moved from an open/unlatched or fail-safe position to a latched position, this movement forces switch actuator 102 to rotate, in FIG. 6, counter-clockwise to the lowermost position of groove 110. Such movement causes cam 506, which is fixably connected to actuator 102, to be also rotated about camshaft 602 in a counterclockwise direction. This movement of cam 506 also causes magnet 604 to move in a counterclockwise direction while simultaneously tensioning (i.e. adding energy to) helical spring 502.

In the rare occurrence that switch actuator 102 is somehow damaged such that switch actuator 102 is no longer directly connected or coupled to fork bolt 102 (this may occur if switch actuator 102 is sheared off of cam 506 as a result of fatigue or other material failure), helical spring 502 will operate to rotate cam 506 (and thus magnet 604) from the position indicating that the associated latch is closed to the fail-safe position 102a indicated in FIG. 6. In this fail-safe position, an electrical signal would be emitted by switch 102 to indicate to the operator of the vehicle (such as through the illumination of a warning lamp or light) that there is some problem associated with either the hood latch or the switch itself.

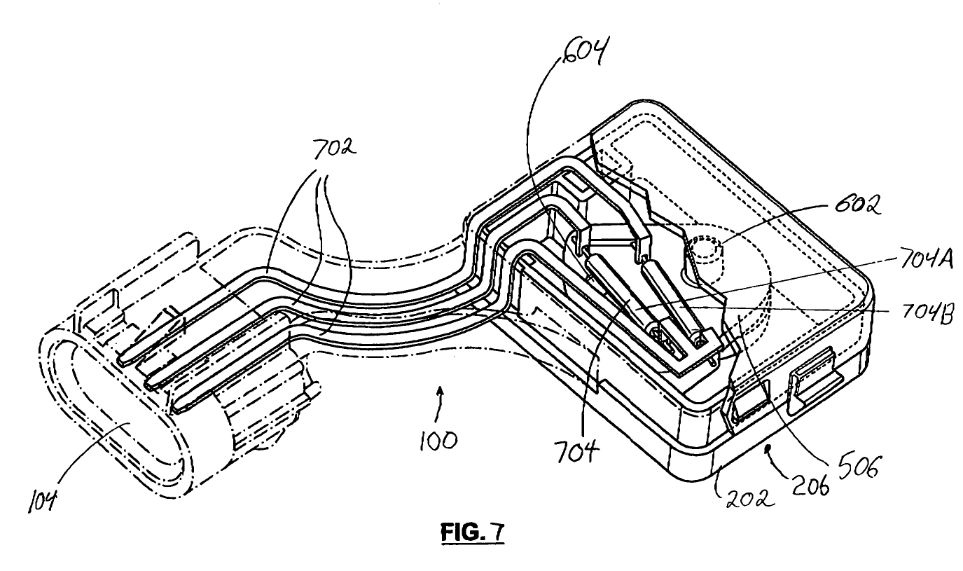

Referencing FIG. 7, switch 100 includes conductors 702 that are, in exemplary embodiment, copper conductors that have been stamped into a specific shape to provide the necessary electrical connection to a connector 104.

Switches known to the inventors feature a printed circuit board (PCB) which connects a connector or wiring harness to the interior reed switches and resistors by way of PCB mounted connectors. These PCB mounted connectors typically are pin-through-hole or surface mounted connectors. Distinctively, the preferred embodiment includes conductors that are fashioned into a specific shape and then encapsulated in suitable material such as, for example, the materials described below. The inventors have realized that a PCB-based circuit impinges upon the ability to properly package the mechanisms necessary for the operation of the switch often resulting in a less than optimal mechanism design, arrangement or an overall increase in the size. In distinct contrast, the preferred embodiment includes conductors which can be fashioned into nearly any shape (unlike a PCB which, due to the environmental conditions in which the switch and PCB operate, needs to be relatively planar and mechanically robust).

In the embodiment illustrated in FIG. 7, the copper conductors 702 have been stamped into a complex three dimensional shape connecting the reed switches (illustrated as reed switches 704 in FIG. 7) to connector 104. The conductors 702 are, during the manufacturing process, encapsulated in suitable material thus providing both electrical insulation while at the same time providing protection and an improved level of reliability and longevity of switch 100.

Reed switches 704 (in the exemplary embodiment illustrated in FIG. 7, reed switches 704A and 704B) are conventional sealed switches and include contacts in a hermetically sealed glass tube filled with a protective gas. While reed switches 704 are generally considered to be fairly robust. However, the inventors of the present invention have identified that reed switches exposed to the vibrations of ultrasonic welding (such a process being used in the manufacturing of switches known to the inventors) vibrations often render such reed switches completely inoperative or result in damage the switches. The extent of this damage is often of a level of severity that impacts the longevity and durability of the entire switch when the switch is stressed by the environmental conditions in which vehicles operate. Consequently, the damage to the reed switches caused by ultrasonic welding often causes early failure of reed switches 704 and the switch as a whole.

As will be appreciated by those of ordinary skill the art, reed switches 704 could be replaced, in alternative embodiments, with other switching devices. These other switching devices could leverage mechanical properties or electromagnetic properties (a reed switch leverages electromagnetic properties). For example, cam 506 could be used to toggle a microswitch between the on and off states. Alternatively, a sliding contact switch could also be employed. Also, if desired, alternative embodiments of the present invention may employ Hall effect switch(es) in place of the reed switch(es). Other switching devices could also be employed in further alternative embodiments.

In the exemplary embodiment, in addition to the use of snap assemblies 206 which prevents such vibratory damage, reed switches 704 and conductors 702 are encapsulated in a suitable material which provides additional and enhanced protection of reed switches 704 and conductors 702. The encapsulation process improves the overall durability and reliability of switch 100.

In the exemplary embodiment, the encapsulation or potting of these components uses of a two-part epoxy or a thermoplastic elastomer. In one embodiment Hysole® potting compound (available from Loctite Corporation of the U.S.) is employed. In a different embodiment, thermoplastic polymer—Techbond® 6700-65, a styrenic block copolymer from Teknor Apex Company of Pawtucket, R.I.—is employed. Both of these potting compounds provide additional and enhanced protection of reed switches 704 while displaying the physical properties desirable for mounting of the associated switch in a vehicle's engine compartment.

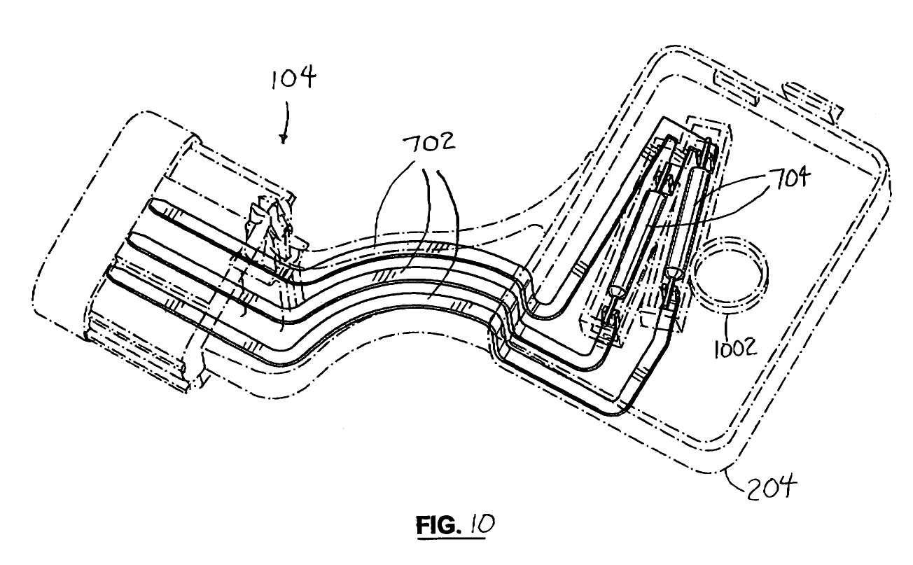

Referencing FIGS. 9 and 10, cam 506, incorporating switch actuator 102, also includes a camshaft or post sleeve 902 which is sized and arranged to slide onto camshaft 602 (shown in FIGS. 6-8) thus enabling cam 506 to smoothly rotate about camshaft 602. Additionally, to further stabilize and secure cam 506 within the confines of cover 202 and a base substrate 204 (FIG. 2). Base substrate 204 includes a circular cavity 1002 to secure cam 506 in a fixed lateral and longitudinal position within the confines of switch 100. Circular cavity 1002 is shaped to allow for the relatively smooth rotation of cam 506 about the axis defined by camshaft 602 (FIGS. 6-8). Further, circular cavity 1002 is adapted to receive the terminating end of camshaft 602 when cover 202 and base substrate 204 are snapped into position through operation of snap assemblies 206. As a result of the interaction between cover 202, base substrate 204, snap assemblies 206, camshaft 602 and circular cavity 1002, cam 506 is longitudinally and laterally fixed within switch 100 but allowed to freely rotate (within the limits defined by the movement of switch actuator 102 within actuator groove 110) about camshaft 602.

The manufacturing operation of switch 100 will be better understood with particular reference to FIGS. 1, 2, 4, 6, 7, 8, 9 and 10. The base substrate 204 receives reed switches 704A and 704B and connector 104. Conductors 702 are stamped and arranged to electrically connect reed switches 704 to the electrical connections of connector 104. Thereafter, conductors 702 and reed switches 704 are encapsulated in a suitable encapsulation material such as a two part epoxy or thermoplastic elastomer.

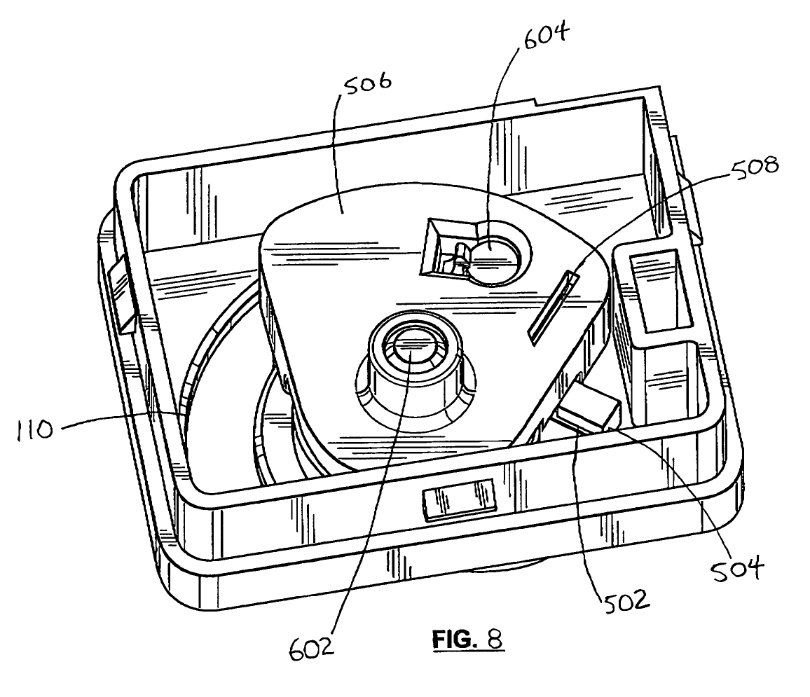

With reference to FIGS. 8 and 9, magnet 604 is fixedly mounted to cam 506. Additionally, one end of helical spring 502 is received by locking recess 508 that forms part of cam 506. Spring 502 is pre-tensioned and placed within spring-tensioning recess 504 that is substantially concentric about camshaft sleeve 902. Cam 506, incorporating magnet 604 and spring 502, slides onto camshaft 602 that forms part of cover 202. Additionally, cam 506 is positioned about camshaft 602 such that spring terminus 906 (shown in FIG. 9) is received by spring locking recess 504 which forms part of cover 202. Still further, cam 506 is positioned about camshaft 602 in a manner that switch actuator 102 is positioned within actuator groove 110 of cover 202. As a result of the positioning of cam 506 relative to cover 202, switch actuator 102 will be positioned at its fail-safe position—illustrated as position 102a in FIG. 4.

Cover 202 is then brought into a position proximate to base substrate 204 and these two components are forced together and locked into a relatively fixed position through operation of snap assemblies 206. During this procedure, the upper portion of cam 602 and camshaft sleeve 902 will be positioned within the interior of circular cavity 1002 of base substrate 204 thus providing additional strength and rigidity to switch 102 and the components therein. Additionally, as a result of the use of snap assemblies 206, switch 100 can be quickly disassembled, inspected and/or repaired and re-assembled without any special tools or processes.

Still referencing FIGS. 1, 2, 4, 5, 6, 7 and 8, switch 100, prior to installation within a vehicle, will have switch actuator 102, in the fail-safe position 102a illustrated in FIG. 4. In this fail-safe position, magnet 604 will be positioned relative to reed switches 704A and 704B are in a closed position. Accordingly, as a result of the contacts within reed switches 704A and 704B being closed, the equivalent resistance for the circuit will be a function of the resistance of reed switches 704A and 704B. That is, the equivalent resistance of the circuit wherein magnet 604 has closed the contacts of both reed switches 704A and 704B will be defined by the formula below (where R₁ and R₂ are the resistance of reed switches 704A and 704B, respectively, and Rₚ is the equivalent resistance for the entire circuit):

$${R}_{p} = \frac{{R}_{1} \cdot {R}_{2}}{{R}_{1} + {R}_{2}}$$

If it is detected that the resistance exhibited by automotive switch 100 is the result of the contacts of both reed switches 704 being in the closed position (i.e., in conformity with the above equation), the diagnostics of the vehicle into which switch 100 has been installed, will operate to turn on the appropriate indicator lamp. This indicator lamp is viewable by the driver of the vehicle and provides a warning that the hood is possibly in an unlatched and dangerous position. Additionally, circuitry within the vehicle will disable any remote-starting device within the vehicle. Accordingly, if the vehicle is not in operation, but the fail-safe switch 100 indicates that the hood latch is open, a person attempting to remote start the vehicle will be prevented from doing so. In the event that the vehicle is operating (whether idling or in motion), an indicator light will be turned on warning an occupant or a driver that the hood (or other door, hatch or tailgate with which the switch is associated) is in an unlatched and unsafe position.

During installation of switch 100 into a vehicle, switch 100 will be positioned and mounted to a latching mechanism such as a fork bolt 106 (shown in FIGS. 1 and 2). The latching mechanism, such as fork bolt 106, will be placed in direct contact with switch actuator 102. Also, switch 100 will be positioned relative to fork bolt 106 such that the rotation (in either direction) of fork bolt 106 (which is shown in the unlatched position in FIG. 1) will result in fork bolt 106 being rotated about the axis defined fork bolt post 108. Consequently, fork bolt 106, during a hood closing operation, will force switch actuator 102 from the fail-safe position 102a (illustrated in FIG. 4) to the latched position 102b (shown in dotted outline in FIG. 4). Resulting from the movement of switch actuator 102 from fail-safe position 102a to latched position 102b by switch actuator 110, cam 506 and magnet 604 fixed thereto will be similarly rotated about camshaft 602. Magnet 604 will be rotated to a position where the magnetic field applied to the contacts within reed switches 704 is sufficiently weakened such that the contacts within reed switches 704 are separated. This separation of the contacts will significantly reduce or eliminate the flow of electric current through reed switches 704. As a result of the change in the operation of reed switches 704, a vehicle's control system will effectively measure a very high or infinite level of resistance exhibited by the circuitry of switch 100. This level of resistance will indicate that the associated hood is closed or in a safe position. Accordingly, any warning lamp previously illuminated within the vehicle can be turned off.

As will be apparent to those of ordinary skill in the art, during normal operation of switch 100, the circuitry of switch 100 will exhibit to the control systems of the associated vehicle either a very high or near infinite resistance or resistance described above when the contacts of reed switch 704 are closed. A near infinite resistance indicates that the associate fork bolt and hood (or door, tailgate or the like) are in the closed or safe position. If a vehicle's control system measures the resistance exhibited by switch 100 to be equal to the resistance of a parallel circuit having both reed switches 704A and 704B in a closed (i.e., conducting) position, this resistance is indicative of the hood latch being in an unsafe position. Accordingly, the vehicle's control system will illuminate the required warning lamp warning an operator of the vehicle of the potentially dangerous situation.

In the event that there is a failure of switch actuator 102, cam 506 and, thus magnet 604, will, in most circumstances, move from a position indicating a safe position (reed switches 704 are open) to the fail-safe position (reed switches 704 are closed) indicating an unsafe or unlatched position of the associated hood, door or the like. For example, consider, due to material fatigue or other physical phenomena, switch actuator 102 is sheared from cam 506. In this instance, the rotation of fork bolt 106 will not apply any forces to cam 506 nor prevent the rotation of cam 506 about camshaft 602. However, if helical spring 502 is in the (relatively) high-tensioned state of closed position 102b (as compared to fail-safe position 102a), helical spring 502 will operate to apply a force to cam 506 to rotate cam 506 and magnet 604 from the latched position to the fail-safe position. Accordingly, even though the associated hood may in fact be closed and in a safe position, an operator of a vehicle will be, through the illumination of a warning lamp, warned of a potentially unsafe position. This will provide a warning to the operator of the vehicle to have the vehicle and, more particularly, the latching mechanism including switch 100, inspected and repaired. Additionally, and as noted above, the fail-safe position of switch 100 would prevent the remote-starting of the vehicle.

If switch 100 has been damaged or fails to operate properly such that it is neither in the fail-safe position (illustrated as position 102a in FIG. 4 of switch actuator 100) nor in the unlatched or unsafe position (illustrated as position 102b in FIG. 4), but in some intermediate position, switch 100 will exhibit a level of electrical resistance that is neither extremely high or near infinite (as is the case when the contact of both reed switches 704 are in the separated position) or the level of resistance to both reed switches 704 being closed. In this case, diagnostic equipment (which may form part of a vehicle's onboard control system or be a separate device) will be able to measure such an intermediate level of resistance and, noting this intermediate resistance level, assist in the diagnosis that a failure to switch 100 may have occurred.

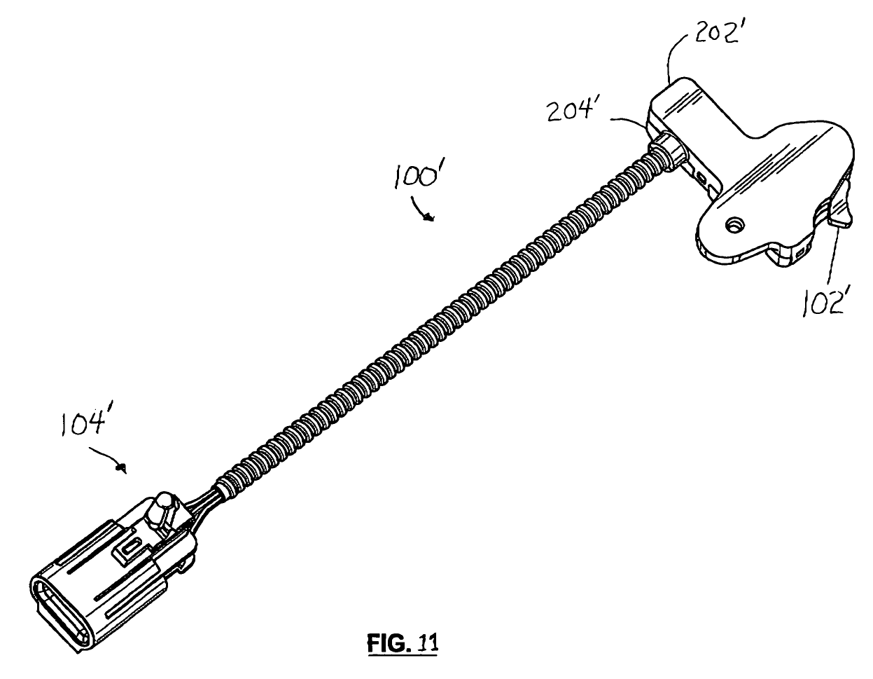

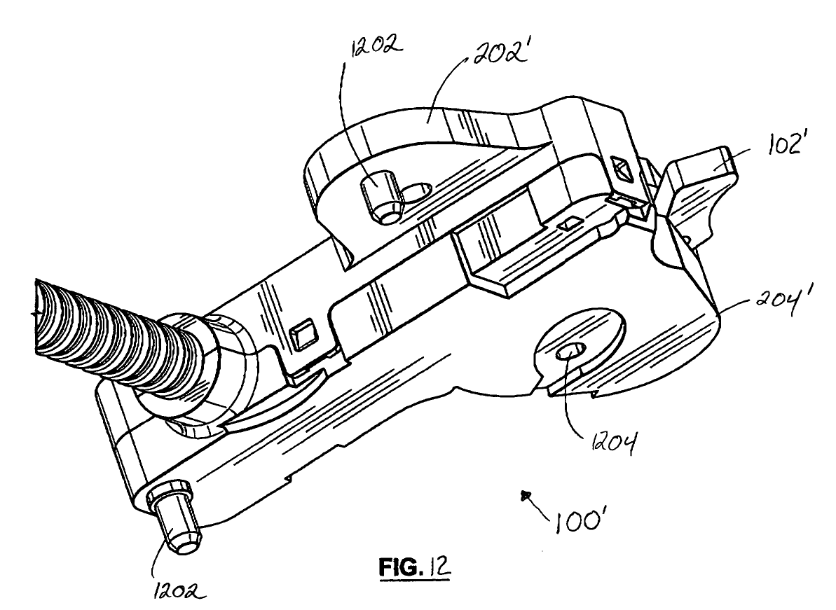

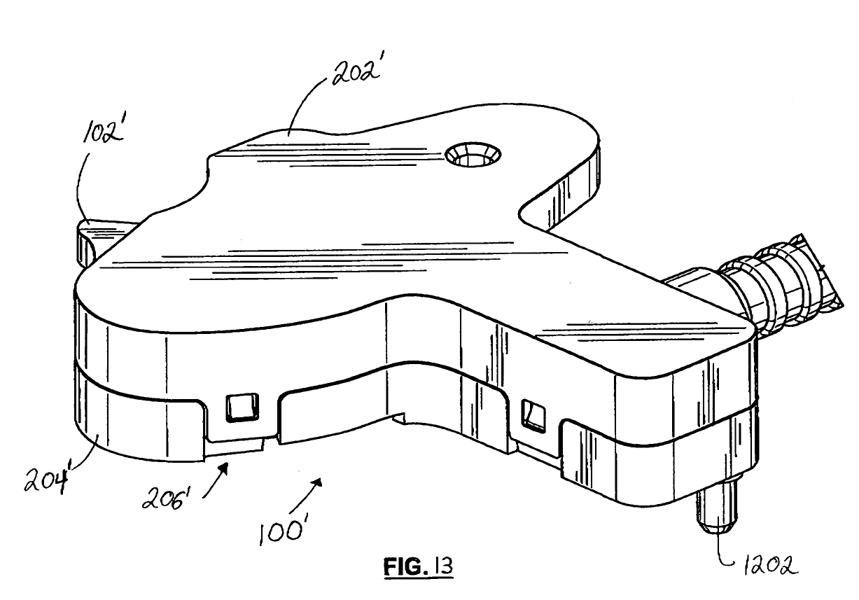

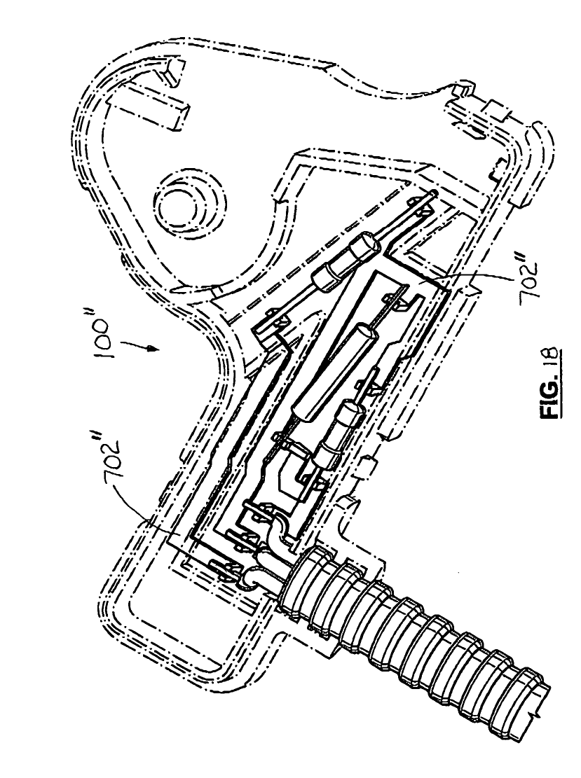

Alternative embodiments of the embodiment of the invention illustrated in FIGS. 1 to 10 are illustrated in FIGS. 11 through 18.

In the automotive switch 100′ illustrated in FIG. 11, switch actuator 102′, rather than protruding through the primary surface of the base substrate as with the previous embodiment, protrudes from the side of the enclosure defined by base substrate 204′ and cover 202′. Actuator 102′ can be moved through either a rotating latch mechanism or a translating mechanism (neither of which are illustrated). Also, rather using the connector of the previous embodiment, switch 100′ of FIG. 11 includes a wiring harness 104′. Further, base substrate 204′ includes optional screw or fastener receptacle 1204 which is used to receive a screw, rivet or other fastener for mounting switch 100′ to a latch. Additionally, switch 100′ includes anti-rotation pins 1202 that ensure that switch 100 does not rotate relative to the latch to which it is mounted.

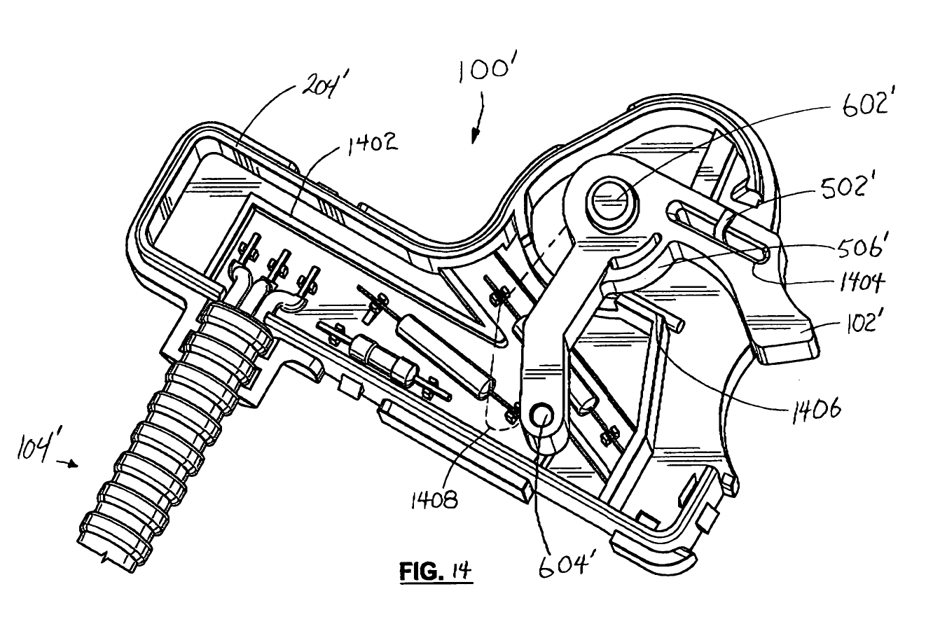

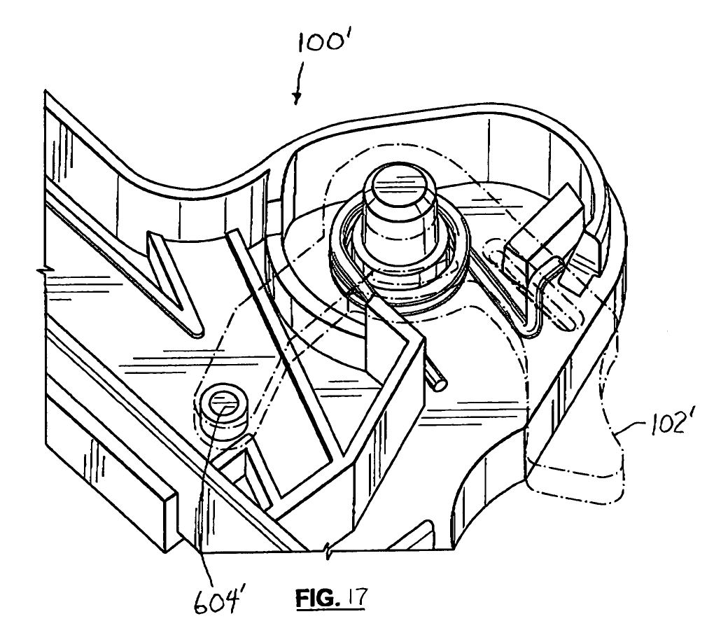

Referencing FIG. 14, the interior of switch 100′ is illustrated. Similar to the first embodiment illustrated in FIGS. 1 through 10, alternative embodiment of switch 100′ includes a cam 506′ (that is rotatably mounted on camshaft 602′) and magnet 604′ fixed to cam 506′. As with switch 100, switch 100′ also includes a helical spring 502′ with one end of the spring biased against a fixing barrier 1406 and the other end biased against cam 506′. The end biased of spring 502′ biased against cam 506′ is mounted within and hooks through spring groove 1404. As cam 506′ rotates about camshaft 602′ from a position shown in FIG. 14 (the fail-safe position) to position 1408 (indicated by dotted line in FIG. 14), spring 502′ will store additional energy. Additionally, the end of helical spring 502′ biased against the interior of spring groove 1404 will translate or move within the groove. The rotation from the fail-safe position to the latched position 1408 of cam 506′ will result in the movement of magnet 604′. As a result of this movement of magnet 604′ from the fail-safe position to the latched position 1408, the connectors of reed switches 704A and 704B moved from a state of contact to a state of separation. In FIG. 17, magnet 604′ has been insert moulded directly into cam 506′ thus fixing magnet 604′ to cam 506′ with a very high degree of reliability and longevity.

Similar to switch 100, switch 100′ also incorporates moulding or encapsulation material 1402 that protects electrical connection and reed switches 704 in extreme moisture conditions while providing additional reliability.

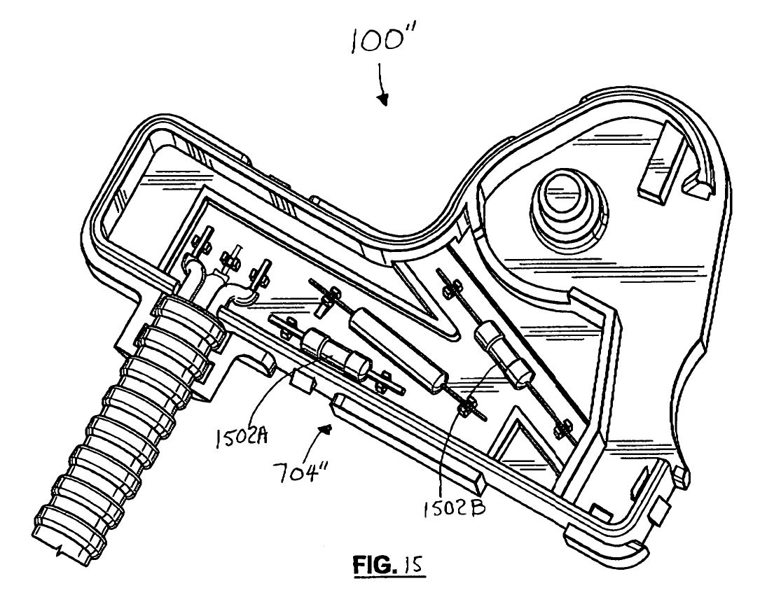

FIG. 15 illustrates a further alternative embodiment of the present invention. In the alternative switch 100″ illustrated in FIG. 15, the dual reed switch circuitry of the previous embodiments is replaced with a double resistor (1502A and 1502B), single reed switch 704″ configuration. In this embodiment, switch 100″ does not include the ability to provide the advanced diagnostic feature (wherein an intermediate level of circuitry resistance indicates a condition of a first reed switch in the open condition and the second reed switch being closed) of the previous embodiments.

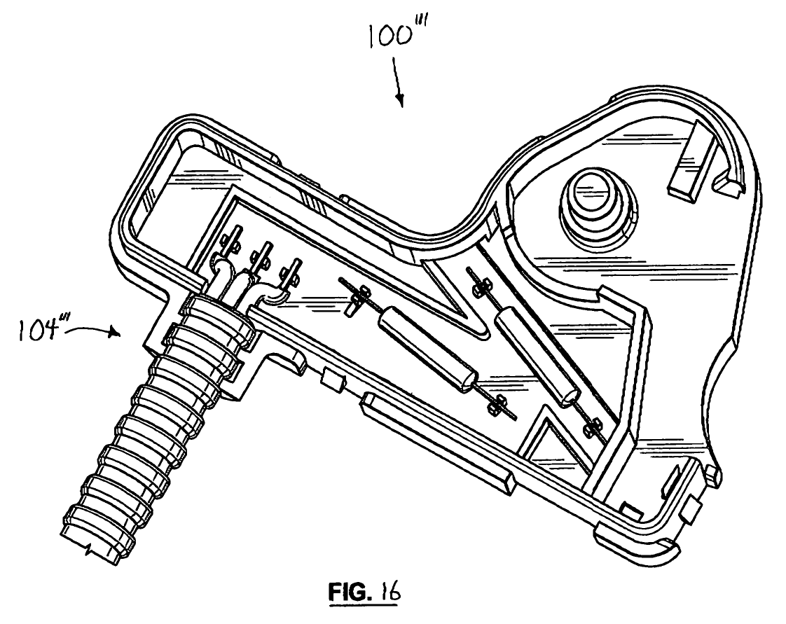

FIG. 16 illustrates a still further alternative embodiment of the present invention. Switch 100′″ illustrated in FIG. 16 a triple wire wiring harness 104′″ is employed with the dual reed switch circuitry (which was employed in embodiments 100 and 100′). In FIG. 17, magnet 604′″. Switch 100′″ also includes insert moulded directly into base substrate 204′″ which provides enhanced reliability of switch 100′″.

While the switches illustrated in FIGS. 1-16 have been described as resulting in a warning lamp being illuminated when one or more of the reed switches are in closed state and deactivate or turn off the warning lamp when the reed switch(es) are in the open state, alternative embodiments could, for example, illuminate the warning lamp when the reed switch(es) is(are) in the open state and deactivate the warning lamp when the reed switch(es) is(are) in the closed state.

In a further alternative embodiment of the present invention, a portion of the latching mechanism (e.g., the fork bolt) could effectively replace the cam in the switches heretofore. That is, a portion of the latching mechanism effectively acts as the cam. In this alternative embodiment, a magnet would be fixed (e.g., attached, embedded within, etc.) relative to the latching mechanism portion. The movement of this portion (e.g., the movement of the fork bolt) would then result in the movement of the magnet to a position which would cause the reed switches to switch state (i.e., change from open to closed, or vice versa).

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

1. A latching mechanism switch comprising:
(a) an enclosure;
(b) a switching device fixedly mounted within said enclosure; and
(c) a cam rotatably mounted to said enclosure, said cam for direct engagement with an associated latching mechanism and said cam having a magnet fixedly mounted thereto, wherein rotation of said cam and said magnet from a first position to a second position causes said switching device to change from an open state to a closed state and wherein rotation of said cam and said magnet from said second position to said first position causes said first switching to change from said closed state to said open state.

2. The latching mechanism switch of claim 1 wherein said cam comprises a portion of said associated latching mechanism and said magnet is fixedly mounted to said portion of said portion of said associated latching mechanism.

3. The latching mechanism switch of claim 2 wherein said portion of said associated latching mechanism comprises a fork bolt.

4. The latching mechanism of claim 1 wherein said switching device comprises one of a microswitch, a sliding contact switch, a reed switch and a Hall effect switch.

5. The latching mechanism of claim 1 wherein said switching device comprises a first reed switch.

6. The latching mechanism switch of claim 5 further comprising:
(a) a second reed switch fixedly mounted within said enclosure;
wherein said rotation of said cam and said magnet from said first position to said second position also causes said second reed switch to change from an open state to a closed state and wherein rotation of said cam and said magnet from said second position to said first position causes said second reed switch to change from said closed state to said open state.

7. The latching mechanism switch of claim 6 wherein said latching mechanism switch exhibits:
(a) a first electrical resistance in said first position indicative of an associated latch being closed;
(b) a second electrical resistance in said second position indicative of an associated latch being open or said latching mechanism switch having failed; and
(c) a third electrical resistance in a third position, said third position being between said first and second positions, said third electrical resistance indicative of a failure of said latching mechanism switch.

8. The latching mechanism switch of claim 1 wherein a vehicle including said latching mechanism switch is prevented from being started remotely when said switching device is in only one of said open or closed states.

9. The latching mechanism switch of claim 1 electrically connected to a warning instrument, said warning instrument emitting a signal warning an occupant of a vehicle including said latching mechanism switch when said switching device is in only one of said open or closed states.

10. The latching mechanism switch of claim 1 further comprising:
(a) a biasing mechanism biasing said cam and said magnet towards said second position.

11. The latching mechanism switch of claim 10 wherein said biasing mechanism comprises a helical spring, a first end of said helical spring in a position fixed relative to said cam and a second end of said helical spring in a position fixed relative to said enclosure, said helical spring biasing said cam and said magnet towards said second position.

12. The latching mechanism switch of claim 7 wherein said cam comprises a switch actuator fixed to said cam, said switch actuator for direct engagement with an associated latching mechanism.

13. The latching mechanism switch of claim 1 wherein said enclosure comprises:
(a) a cover; and
(b) a base substrate;
said cover fixed to said base substrate by one or more snap assemblies.

14. The latching mechanism switch of claim 1 further comprising:
(a) conductors for connecting said switching device to an associated wiring harness;
said conductors and said switching device encapsulated in an encapsulation material electrically insulating and protecting said conductors and said switching device.

15. The latching mechanism of claim 15 wherein said conductors are stamped and formed into a shape for electrically connecting said switching device to an associated wiring harness; and wherein said encapsulating material comprises one of an epoxy and a thermoplastic resin.

16. A method of operating a latching mechanism switch, said method comprising:
(a) directly engaging a portion of said latching mechanism switch with a portion of an associated latching mechanism; and
(b) moving said latching mechanism from a first, unlatched position to a second, latched position causes a first reed switch of said latching mechanism switch to change from an open state to a closed state, and wherein moving said latching mechanism from said second position to said first position causes said first reed switch to change from said closed state to said open state.

17. The method of claim 17 further comprising:
(a) if said direct engagement between a portion of said latching mechanism switch and said portion of said associated latching mechanism fails, biasing said latch mechanism switch device to cause said reed switch from one of said open state and said closed state to the other of said one of said open state and said closed state.

18. The method of claim 17 further comprising:
(a) moving said latching mechanism from said first position to said second causes a second reed switch of said latching mechanism switch to change from an open state to a closed state, and wherein moving said latching mechanism from said second position to said first position causes said second reed switch to change from said closed state to said open state.

19. The method of claim 18 further comprising:
(a) exhibiting a first electrical resistance in said first position indicative of said latching mechanism being closed;
(b) exhibiting a second electrical resistance in said second position indicative of said associated latching mechanism being open or said latching mechanism switch having failed; and
(c) exhibiting a third electrical resistance in a third position, said third position being between said first and second positions, said third electrical resistance indicative of a failure of said latching mechanism switch.

20. A vehicle comprising a latching mechanism and a latching mechanism switch, said latching mechanism switch associated with said latching mechanism, said latching mechanism switch comprising:
(a) an enclosure;
(b) a first reed switch fixedly mounted within said enclosure; and
(c) a cam rotatably mounted within said enclosure, said cam for direct engagement with said associated latching mechanism and said cam having a magnet fixedly mounted thereto, wherein rotation of said cam and said magnet from a first position to a second position causes said first reed switch to change from an open state to a closed state and wherein rotation of said cam and said magnet from said second position to said first position causes said first reed switch to change from said closed state to said open state.

21. The vehicle of claim 20 wherein said latching mechanism switch further comprises:
(a) a second reed switch fixedly mounted within said enclosure;
wherein said rotation of said cam and said magnet from said first position to said second position also causes said second reed switch to change from an open state to a closed state and wherein rotation of said cam and said magnet from said second position to said first position causes said second reed switch to change from said closed state to said open state.

22. The vehicle of claim 21 wherein said latching mechanism switch exhibits:
(a) a first electrical resistance in said first position indicative of said associated latch being closed;
(b) a second electrical resistance in said second position indicative of said associated latch being open or said latching mechanism switch having failed; and
(c) a third electrical resistance in a third position, said third position being between said first and second positions, said third electrical resistance indicative of a failure of said latching mechanism switch.

23. The vehicle of claim 20 further comprising a warning instrument associated with said latching mechanism switch, said warning instrument emitting a signal warning an occupant of said vehicle when said reed switch of said latching mechanism switch is in only one of said open or closed states.

24. The vehicle of claim 20 wherein said vehicle is prevented from being started remotely when said reed switch is in only one of said open or closed states.

25. The vehicle of claim 20 wherein said latching mechanism switch further comprises:
(a) a helical spring, a first end of said helical spring in a position fixed relative to said cam and a second end of said helical spring in a position fixed relative to said enclosure, said helical spring biasing said cam and said magnet towards said second position.
